(19) United States
(12) Patent Application Publication
(10) Pub. No.: US 2024/0297373 A1
(43) Pub. Date: Sep. 5, 2024

(54) ELECTRICAL AUTOMOBILE WITH A FUEL CELL SYSTEM AND A METHOD OF FIRE-RISK MITIGATION

(71) Applicant: BLUE WORLD TECHNOLOGIES HOLDING APS, Aalborg Oest (DK)

(72) Inventors: Mads BANG, Støvring (DK); Martin STENILD GRØN, Skals (DK)

(73) Assignee: BLUE WORLD TECHNOLOGIES HOLDING APS, Aalborg Oest (DK)

(21) Appl. No.: 18/575,651

(22) PCT Filed: Jun. 30, 2022
(86) PCT No.: PCT/DK2022/050152

§ 371 Date: Dec. 29, 2023

(30) Foreign Application Priority Data
Jul. 5, 2021 (DK) PA202100719
Apr. 7, 2022 (DK) PA202200328

(51) Int. Cl. H01M 16/00; B60L 3/00; H01M 8/04014; H01M 8/04119; H01M 8/04746; H01M 8/0612; H01M 8/10

(52) U.S. Cl. CPC H01M 16/006; B60L 3/0053; H01M 8/04014; H01M 8/04164; H01M 8/04776; H01M 8/0618; H01M 2008/1095; H01M 2220/20; H01M 2250/20

(57) ABSTRACT

In order to reduce the risk for fire due to hydrogen leaks from a fuel cell in an electric automobile, the fuel cell compartment is steadily flushed with cathode exhaust gas.

### FIELD OF THE INVENTION

The present invention relates to an automobile with a fuel cell system in a casing attached to the underside of the car and mitigation of risk for fire and explosion due to hydrogen leaks from the fuel cell.

### BACKGROUND OF THE INVENTION

In some constructions of electrically driven automobiles, a fuel cell (FC) is provided in a closed container that is attached to the underside of the car. Examples are disclosed in US patent applications US2004/0062955, US2004/0058215, CN110588382A, and WO2021/078343.

In practice, the position of the container imposes some strict requirements for tightness of the enclosure, as dust and humidity must not enter the container. Among the required standards is the Ingress Protection Code (IP) 67, where the numeral 6 stand for dust tightness and the 7 stands for water tightness up to a pressure of 1 meter water submersion.

Having such a closed container, implies a risk for hydrogen gas (H2) from the fuel cell leaking into the container and the accumulation of H2 causing fire and explosion. Risk mitigation in relation to hydrogen leakage from fuel cells has been discussed generally in the prior art.

US2019/385245 discloses a domestic fuel cell power plant in which H2 from leaks is diluted with environmental air as well as exhaust air from the FC in the power plant, where the mix is made such that the oxygen content is kept low. For provision of the air flow from the environment, a ventilator blows air into the enclosure of the power plant. Such system is not useful for automobiles in which the FC system is provided underneath the car in a container, as air suction would also include dust and humidity into the container.

Japanese patent JP3509132B2 and corresponding patent application JP7022044A2, disclose use of cathode gas filled into the container around the FC for risk mitigation. It does not describe the gas flow through the system and also not the gas flow in general with respect to a FC container for automobiles, in which also battery and electronics are contained.

US2017/0125831 discloses use of exhaust gas as an extinguishing agent, for fire suppression, however, not on a steady-state basis for continuous fire prevention. US2021/0202965 discloses a system in which exhaust gas is kept in a tank for purging when the system is off.

U.S. Pat. No. 10,507,345 discloses a system where oxygen depleted air (ODA) is used for flushing the FC container as well as the separate container with batteries and the electronics compartment. Although generalized to any type of vehicle, the system in U.S. Pat. No. 10,507,345 is primarily made for air planes, seeing that the ODA is also used for fire risk mitigation in avionics compartments. In the system, a regulator is functionally connected to a controller that causes the regulator to regulate the distribution of the gas to the respective compartment only in dependence on an alarm signal received from a sensor in the respective compartment. Without alarm signal, there is no distribution of the FC gas. Such a system is not useful for the container underneath the automobile, where the security standard is high even in the case of a malfunctioning sensor. Also, complex systems as in U.S. Pat. No. 10,507,345 are less useful for automobiles, where space and weight is a great concern.

Discharge of hydrogen from fuel cells in automobiles is disclosed in US2002/094469. German patent application DE102012018513A1 discloses a fuel cell system for a vehicle, where the fuel cell is contained in an enclosure that is flushed with dried cathode gas, which is recycled after drying in a dryer that is located outside the enclosure.

It would be desirable to find improved technical solutions for FC systems in casings on the underside of automobile carrosseries.

### DESCRIPTION OF THE INVENTION

It is an objective to provide an improvement in the art. In particular, it is an objective to provide an improved technical solutions for FC systems in a casing underneath the cabin of automobiles, in particular with respect to dust and water tightness and with respect to risk mitigation for fire and explosion caused by H2 leaks. These and more objectives are achieved with a system and method as described in the claims and in more detail in the following.

In particular, the objective is achieved by a method and system for reducing the risk for fire due to hydrogen leaks from a fuel cell in an electric automobile, where the fuel cell compartment is flushed with cathode exhaust gas.

The electrically powered automobile comprises a power-pack that provides electrical power to electrical engine that rotate wheels of the automobile. The power-pack is arranged underneath the cabin of the automobile, typically secured to the chassis of the automobile. For example, the casing of the power-pack has a width in the range of 1 to 3 m. Optionally, the length is in the range of 1 to 4 m. A typical height of the casing is in the range of 0.1 to 0.4 m.

The power-pack comprises a generally closed casing with an interior that contains a battery as well as a fuel cell for charging the battery. Although, the singular term is used for the battery and the fuel cell, the power-pack will usually comprise a plurality of interconnected batteries and a fuel cell stack. Typically, the power-pack is dimensioned to provide power enough for electrically propelling the vehicle over a minimum range of distance of more than 100 km.

The fuel cell comprises an anode and a cathode, where hydrogen is provided to the anode and oxygen to the cathode. For example, a proton exchange membrane is provided for transport of hydrogen ions from the anode side to the cathode side through the membrane during operation. As a result, water is produced by the reaction of oxygen and hydrogen.

As source for oxygen gas in the fuel cell, air is typically used and provided to the cathode side of the membrane in the fuel cell. Optionally, prior to entering the fuel cell, the air is heated by an air heating system for increasing the temperature of the air. Other gases of the air merely flow through the system and are discarded again. During operation of the fuel cell, oxygen is consumed on the cathode of the fuel cell by creation of water with the received protons, and the cathode exhaust gas has a reduced concentration of oxygen, which in the technical field is commonly called Oxygen Depleted Air (ODA).

Due to the reduced content of oxygen in the cathode exhaust gas, it is suitable for preventing fire and explosion or at least reducing the risk thereof in the power-pack. However, for using the ODA, water is removed from the cathode exhaust gas. This is done in a condenser, which has an upstream condenser-side flow-connected to the cathode side of the fuel cell for receiving the cathode exhaust gas from the fuel cell, which contains water vapor. In the condenser, the water is condensed and removed from the cathode exhaust gas. At the same time, the gas is cooled. A portion of the cooled dry cathode exhaust gas from the downstream side of the condenser can then be fed as ODA into the interior of the casing of the power-pack.

The term “cool” or “cooled” gas is used here for a temperature of the gas downstream of the condenser lower than the temperature at of the cathode exhaust gas at the exit of the fuel cell.

For example, the cooled dried cathode exhaust gas is provided from the condenser at a temperature T2 which is below 60°° C., for example in the range of 20-60° C. This is much lower than the temperature of the fuel cell, especially if it is a high-temperature fuel cell, operating at temperatures in the range of 120-200° C.

Although, it is possible to add other gases to the cathode exhaust gas for providing the ODA in the interior of the casing, the sole use of cathode exhaust gas for the flushing is advantageous in many cases is, as this sufficiently minimizes the oxygen gas concentration in the interior of the casing.

During operation of the fuel cell, advantageously as a standard automatic procedure, the feeding of the ODA into the interior of the casing of the power-pack and by creating a flow of the ODA through the interior, oxygen levels inside the interior are reduced and fire-risk mitigated even in the event of a potential hydrogen gas leakage from the fuel cell into the interior, as the ODA is steadily renewed in the interior. The ODA is provided through a feeder, typically a feeder-valve, so that there is a steady flow through the interior as soon as the fuel cell starts operating and at all times during operation of the fuel cell. The flow may be continuous or intermittent with short breaks, if so desired. Important is that the oxygen concentration is kept low in the interior at all times of operation of the fuel cell, independently of the hydrogen level in the casing.

The latter is in contrast to the aforementioned U.S. Pat. No. 10,507,345, where ODA is only supplied to the fuel cell container in case of a sensor measuring elevated hydrogen levels and an alarm signal is created.

In order to provide the power-pack in IP67 standard, the casing must be protected against ingress of dust and water from the environment. A good technical solution has been found in keeping the interior of the power-pack casing at a pressure above ambient pressure.

In order to provide a flow through the interior while maintaining elevated pressure above ambient pressure, a gas vent mechanism is provided, which is configured for releasing gas when the pressure inside the casing, for example in one or more selected compartments of the casing, exceeds a predetermined threshold. In some embodiments, the gas is released from the interior of the casing only to the environment.

For release of the ODA, a release-valve is arranged between the interior and the environment, for example arranged in the casing. The release-valve is configured for releasing the pressurized ODA together with potentially leaked hydrogen gas from the interior of the casing only to the environment and not into the cabin. It will release the ODA from the interior when the pressure of the gas in the interior is at a predetermined pressure P1 above a pressure P0 of the environment around the automobile. For example, P1 is 2-10%, for example 5-10%, higher than P0.

For example, the release-valve is a one-way release-valve having a closure member resiliently prestressed against a valve seat with a resilient force against flow through the release-valve and configured for opening for flow through the release-valve from the interior to the environment only when the pressure difference between P1 and P0 provides a counterforce on the closure member exceeding the resilient force. Such a simple and light-weight solution is advantageous in many cases, although, other alternatives exist, for example an electronically regulated valve coupled to a pressure gauge.

In case that the fuel cell is not operated at higher pressure than the pressure in the interior of the casing, the feeder may comprise a pump that increases the pressure and moves the ODA through the casing.

However, in some embodiments, a compressor is compressing air for feeding the fuel cell with oxygen. Due to the compression, the fuel cell is operating at elevated pressure. Accordingly, when the fuel cell is operating, the exhaust gas from the cathode is also at elevated pressure, and, after cooling in a condenser, the cooled dry cathode exhaust gas is released through an exhaust. For maintaining the pressure in the fuel cell, the automobile comprises a back-pressure-valve, which is different from the release-valve in the casing, and which is located in a flow path between the condenser and an exhaust to the environment. It maintains a fuel-cell-back-pressure P2, for example in the range of 0.5-2 bar above environmental pressure.

The feeder, for example feeder-valve, for feeding the ODA into the casing is provided in the flow path between the condenser and the back-pressure-valve. While the fuel-cell-back-pressure is maintained at the predetermined level P2, only a portion of the dry cathode gas is fed through the feeder into the casing, and at a lower pressure, for example in the range of 0.02-0.2, such as 0.05-0.2 or 0.02-0.1 or 0.05-01 bar (1 bar=100 kPa) above environmental pressure.

Typically, for this purpose, the ODA pressure is adjusted with a pressure regulating valve as part of the feeder prior to flowing into the interior of the casing of the power-pack and finally through the gas vent mechanism, for example release-valve, out of the interior into the environment. In order to keep the oxygen at minimum in the ODA, the flow of dried cathode exhaust gas as ODA through the interior of the casing is without addition of air. As the oxygen content is usually sufficiently low, typically, no other risk-mitigation gases are added. However, in order to create sufficient degree of risk mitigation, the ODA is provided at a rate sufficient to prevent fire or explosion.

Not only does this provide reduced oxygen levels inside the interior at all times of operation of the fuel cell for fire-risk mitigation even in the case of a potential hydrogen gas leakage from the fuel cell into the interior, but the flow can be used for taking-up heat from the volume around the electronics and the fuel cell for cooling the interior at the location of the fuel cell and transporting the heat out of the interior and into the environment.

The back-pressure downstream of the cathode is sufficiently high, and typically much higher, than the pressure needed inside the casing. Typically, the back-pressure level would be too high for the casing. Notice that this mechanism of using the back-pressure that is already present from the pressurised air through the cathode of the fuel cell is different from the system in U.S. Pat. No. 10,507,345, in which a compressor is used downstream of the fuel cell in order to pressurise the ODA from the cathode for flow to the various compartments through a regulator valve arrangement.

For example, the gas vent mechanism, for example including a release-valve, is provided in a wall of the casing facing the underside of the cabin, which would create greater protection of the release-valves than when being directed downwards towards the road. However, it is also possible that the gas vent mechanism, for example a single valve or multiple valves, is releasing the gas to a tube, which gives more flexibility with respect to the point of release of the gas to the environment. As a further alternative, the release-valves are optionally provided inside the tube. Important is the fact that the gas vent mechanism, for example a single valve or multiple valves, are provided between the interior of the power-pack casing and the environment for creating the pressure difference.

Optionally, the portion of the ODE, which is released into the casing from the dried cathode gas is variable and controlled by a controller. For example, the controller adjusts the flow in response to oxygen levels and/or hydrogen levels and/or temperature levels inside the interior of the power-pack casing, however, maintaining a minimum flow at all times. For example, the oxygen concentration is measured inside the casing, and the oxygen level kept below a predetermined level by adjusting the flow rate of the ODA. Alternatively, the flow rate of the ODA is predetermined to be so high that a low oxygen level is ensured at all times. As an option, the hydrogen level is measured inside the casing, and the ODA flow adjusted to maintain the hydrogen level under a certain level at all times. Alternatively, the ODA flow rate is predetermined to be so high that a low hydrogen level is ensured at all times according to expected maximum leakages.

The gas flow is released to the environment and not into the cabin, as a reduced oxygen atmosphere is not desired in the cabin when there are people inside, which is usually the case when the fuel cell is running and the automobile driving. This is in contrast to the aforementioned prior art document US2004/0062955, where cooling air is exchanged between the power-pack and the cabin.

Some fuel cells can be operated by alcohol, for example methanol, as fuel, where the alcohol is transformed into syngas by a reformer. Accordingly, in some embodiments, the interior of the power-pack casing also contains a reformer for catalytic reaction of alcohol and water into syngas for the fuel cell. Advantageously, the dry cathode exhaust gas is also used for taking-up heat up from the reformer during the flow through the interior. Typically, the reformer operates together with a reformer heater, typically called burner, for example provided as a unit. The gas flow cools the volume around the reformer/burner, as heat in the interior caused by the burner/reformer is transported out of the interior and into the environment due to the gas flow.

Optionally, the casing comprises a fuel cell compartment that contains the fuel cell and an electronics compartment that contains electronics, such as a controller for the operation of the fuel cell system, including an electronic power management system, and an insulating wall is provided between the two compartments for protecting the electronic power management system against heat from the fuel cell. Advantageously, the flow through the interior of the power-pack casing is guided through both compartments not only for reduced oxygen content but also for cooling, especially cooling the electronics. Throughputs in and/or bypasses around the insulating wall are used for the flow between the compartments. As the fuel cell has a higher temperature, it is an advantage if the flow is first through the electronics compartment and then through the fuel cell compartment. This way, the gas can take up heat from the components in the electronics compartment.

For some of the embodiments with the reformer, the interior also comprises a reformer compartment than contains a reformer for catalytic reaction of alcohol and water into syngas for the fuel cell. This compartment is typically separated from the fuel cell compartment by an insulating wall between the reformer compartment and the fuel cell compartment. Also in such case, throughputs and/or bypasses are used for providing flow between the compartments, for example a flow first through the fuel cell compartment and then through the reformer compartment.

The interior of the power-pack casing also comprises a battery, for example provided in a battery compartment, separate from the other compartments, optionally with a thermo-insulating wall between the battery compartment and the other compartments.

The gas flow is not necessarily also going through the battery compartment, unless cooling and/or flushing is also desired in that compartment. Accordingly, for some embodiments, the flow of cathode exhaust gas does not go through the battery compartment.

As an option, the release-valve is provided at the reformer compartment for release of the cathode exhaust gas from the reformer compartment. Advantageously, the flow is provided serially through the following compartments, starting with the electronics compartment, then through the fuel cell compartment, then through the reformer compartment, from which the gas exits the casing through the release-valve and out into the environment.

For example, the fuel cell is of the type that operates at a high temperature. The term “high temperature” is a commonly used and understood term in the technical field of fuel cells and refers to operation temperatures above 120° C. in contrast to low temperature fuel cells operating at lower temperatures, for example at 70° C. Specifically, the fuel cell operates in the temperature range of 120-200° C.

Optionally, the fuel cell in the fuel cell system is a high temperature polymer electrolyte membrane fuel cell, (HT-PEM), which operates above 120 degrees Centigrade, differentiating HT-PEM fuel cell from low temperature PEM fuel cells, the latter operating at temperatures below 100 degrees, for example at 70 degrees. The normal operating temperature of HT-PEM fuel cells is the range of 120 to 200 degrees Centigrade, for example in the range of 160 to 170 degrees Centigrade. The polymer electrolyte membrane PEM in the HT-PEM fuel cell is mineral acid based, typically a polymer film, for example polybenzimidazole doped with phosphoric acid. HT-PEM fuel cells are advantageous in being tolerant to relatively high CO concentration and are therefore not requiring PrOx reactors between the reformer and the fuel cell stack, why simple, light-weight and inexpensive reformers can be used, which minimizes the overall size and weight of the system in line with the purpose of providing compact fuel cell systems, for example for automobile industry.

During normal operation, the liquid cooling circuit is taking up heat from the fuel cell in order to keep the temperature stable and in an optimized range. For example, the temperature of the fuel cell is 170 degrees, and the liquid coolant has a temperature of 160 degrees at the entrance of the fuel cell.

By insulating the electronics as well as the battery from the high temperature fuel cell system, the temperature of the components in the various heat-insulated compartments can be precisely and individually controlled. This is possible even when using a single cooling circuit, as the flow of the coolant, which is also a heating medium in certain circumstances, for example during startup, can be controlled individually with respect to flow rate through the various compartments. Therefore, in a further embodiment, the cooling circuit is configured for adjustment of the temperature of the fuel cell and adjustment of the temperature of the batteries by control of flow of coolant from the cooling circuit through the fuel cell and by separate control of flow of coolant through the battery.

For the HT-PEM fuel cell, alcohol is used as part of the fuel for the fuel cell, for example a mix of methanol and water, which is transformed into syngas by a reformer. Accordingly, in some embodiments, the interior of the power-pack casing also contains a reformer for catalytic reaction of alcohol and water into syngas for the fuel cell.

In the heated reformer, the fuel is catalytically reacted into syngas for the fuel cell for providing the necessary hydrogen gas to the anode side of the fuel cell. For the catalytic reaction in the reformer, the provided liquid fuel is evaporated in an evaporator that is conduit-connected to the reformer.

For heating the reformer to the proper catalytic conversion temperature, for example in the range of 250-300 degrees, a reformer burner is provided and in thermal contact with the reformer for transfer of heat to the catalyser inside the reformer. The reformer burner comprises a burner-chamber providing flue gas by burning anode waste gas or fuel or both. For example, the reformer burner provides flue gas at a temperature in the range of 350-400 degrees.

The reformer comprises a catalyser inside a reformer housing, which has reformer walls. For example, the flue gas from the reformer burner is passing along the reformer walls and heats them. In such embodiment, the burner-chamber is in fluid-flow communication with the reformer walls for flow of the flue gas from the burner-chamber to and along the reformer walls for transfer of heat from the flue gas to the reformer walls.

After the transfer of the thermal energy from the flue gas to the reformer walls, remaining thermal energy can be used for heating other components, for example heating the vehicle cabin after heat exchange in a corresponding heat exchanger.

Optionally, the reformer and reformer burner are provided as a compact unit. One way of a compact burner/reformer unit, the reformer walls are tubular and surround the burner walls. However, this is not strictly necessary, and a serial configuration, or a side-by-side configuration of the burner/reformer or a configuration of a burner sandwiched between two sections of the reformer is also possible.

Typically, in fuel cell systems, coolant is glycol based. However, for automobiles in cold areas, glycol is not optimum for the start-up, why other liquids are preferred. Examples of such other liquids include synthetic oils.

In some useful embodiments, the system comprises a startup heater for heating the fuel cell system during startup conditions prior to normal power producing fuel cell operation. During startup of the fuel cell system, the fuel cell has to be heated up for reaching a steady state electricity-producing state. Especially for use in vehicles, the start-up procedure should be fast. Typically, this is done in practice by transferring the heat from the startup burner gas to the coolant in the cooling cycle which during start-up is used as heating fluid, instead, in order to heat up the fuel cell to a temperature suitable for normal power producing operation.

### ASPECTS

In the following, a number of interrelated aspects are given in relation to the invention.

ASPECT 1. A method of fire-risk mitigation in an electrically powered automobile (1), the automobile (1) comprising
a cabin (1A);
electrical engines (37) for rotating wheels (36) of the automobile (1);
a power-pack (30) for providing electrical power to the engines (37); wherein the power-pack (30) is arranged underneath the cabin (1A) and comprises a closed casing (13) with an interior that contains a battery (12) as well as a fuel cell (6) for charging the battery (12);
a condenser (42) inside the casing (13), the condenser (42) having an upstream side flow-connected to a downstream of a cathode (6A) of the fuel cell (6) for receiving cathode exhaust gas from the fuel cell (6) and for condensing water out of the cathode exhaust gas and for cooling and drying cathode exhaust gas to a downstream side of the condenser (42);
a feeder (43) downstream of the condenser (42) and configured for releasing a portion of the dried cathode exhaust gas as dry, oxygen depleted air, ODA, into the casing (13) at a pressure above a pressure of the environment (39) for maintaining elevated pressure in the interior of the casing (13) relatively to the pressure of the environment (39) around the automobile (1) for preventing ingress of air and humidity from the environment (39) into the interior of the casing (13);
a release-valve (31) arranged between the interior of the casing (13) and the environment (39) and configured for releasing the pressurised ODA from the interior of the casing (13) only to the environment (39) and not into the cabin (1A), the release-valve (31) being configured for maintaining the elevated pressure in the interior of the casing (13) and releasing the gas from the interior of the casing (13) to the environment (39) only if the pressure of the gas in the interior is above a predetermined pressure level; the method comprising
operating the fuel cell (6) and charging the battery (12) with electrical power from the fuel cell (6);
automatically as a standard procedure, independently of the hydrogen level in the casing (13), and during all times of operation of the fuel cell, causing flow of a portion of the cooled dry cathode exhaust gas through the feeder (43) into the interior and through the interior to the release-valve (31) and through the release-valve (31) out of the interior into the environment (39), but not into the cabin (1A), for reducing fire-risk by creating reduced oxygen levels inside the interior of the casing (13) during all times of operation of the fuel cell (6) and by flushing potentially leaked hydrogen gas out of the interior and by removing heat from the interior;
while providing a flow of ODA through the interior of the casing (13) and out of the release-valve (31), maintaining the elevated pressure in the interior of the casing (13) for preventing ingress of dust and water from the environment (39) into the interior.

ASPECT 2. A method according to aspect 1, wherein the automobile (1) comprises an air compressor (40) flow-connected to an inlet of the cathode (6A) for providing pressurised air to the cathode (6A), and wherein the automobile (1) comprises a back-pressure-valve (41), different from the release-valve (31), located in a flow path between the condenser (42) and an exhaust (3) to the environment (39) for maintaining a fuel-cell-back-pressure for the fuel cell (6), wherein the feeder (43) is provided in the flow path between the condenser (42) and the back-pressure-valve (41); wherein the method comprises maintaining a back-pressure with the back-pressure-valve at a predetermined level P2 and releasing a portion of the dry cathode gas through the feeder (43) at a lower pressure into the casing (13).

ASPECT 3. A method according to aspect 2, wherein the method comprises maintaining a back-pressure P2 by the back-pressure-valve in the range of 0.5-2 bar (1 bar=100 kPa) above environmental pressure.

ASPECT 4. A method according to any one of the preceding aspects, wherein the method comprises providing a flow through the feeder (43) only to a level that provides a pressure in the interior of the casing in the range of 0.05-0.2 bar (1 bar=100 kPa) above environmental pressure.

ASPECT 5. A method according to any preceding aspect, wherein the feeder (43) is a feeder-valve and wherein the method comprises operating the feeder-valve (43) so as to provide a predetermined steady flow of ODA through the casing (13) from the feeder-valve (43) to the release-valve (31) at all times when the fuel cell (6) is operating.

ASPECT 6. A method according to any preceding aspect, wherein the flow of dried cathode exhaust gas as ODA through the interior of the casing (13) is without addition of air or other gases.

ASPECT 7. A method according to any preceding aspect, wherein the cooled dried cathode exhaust gas is provided from the condenser (42) at a temperature T2 which is below 60° C., for example in the range of 20-60° C.

ASPECT 8. A method according to any preceding aspect, wherein the fuel cell (6) is a high temperature polymer electrolyte membrane HT-PEM fuel cell, and the method comprises operating the fuel cell (6) at a temperature in the range of 120-200° C.

ASPECT 9. A method according to any preceding aspect, wherein the casing (13) comprises a fuel cell compartment (16) that contains the fuel cell (6) and an electronics compartment (17) that contains electronics (10, 20), including a controller (10) for the fuel cell system, and wherein an insulating wall (23) is provided between the two compartments (16, 17) for protecting the electronics (10, 20) against heat from the fuel cell (6), wherein the method comprises providing a flow of the ODA first through the electronics compartment (17) and then through the fuel cell compartment (16) and removing heat first from the electronics compartment (17) and then from the fuel cell compartment (16).

ASPECT 10. A method according to aspect 9, wherein the interior of the casing (13) also comprises a reformer compartment (15) than contains a reformer (8) for catalytic reaction of alcohol and water into syngas for the fuel cell (6) and an insulating wall (22) between the reformer compartment (15) and the fuel cell compartment (16), and wherein the method comprises providing flow through the fuel cell compartment (16) prior to flow through the reformer compartment (15), wherein the release-valve (31) is provided at the reformer compartment (15) for release of the ODA into the environment (39) from the reformer compartment (15), wherein the method comprises providing the flow through the electronics compartment (17), then through the fuel cell compartment (16), then through the reformer compartment (15), then through the valve (31) and into the environment (39).

ASPECT 11. A method according to anyone of the aspects 9 or 10, wherein the interior also comprises a battery compartment (14) that contains the battery (12), and wherein the flow of ODA is not through the battery compartment (14).

ASPECT 12. A method of fire-risk mitigation in an electrically powered automobile (1), the automobile (1) comprising
a cabin (1A);
electrical engines (37) for rotating wheels (36) of the automobile (1);
a power-pack (30) for providing electrical power to the engines (37); wherein the power-pack (30) is arranged underneath the cabin (1A) and comprises a closed casing (13) with an interior that contains a battery (12) as well as a fuel cell (6) for charging the battery (12);
a condenser (42) inside the casing (13), the condenser (42) having an upstream side flow-connected to a downstream of a cathode (6A) of the fuel cell (6) for receiving cathode exhaust gas from the fuel cell (6) and for condensing water out of the cathode exhaust gas and for cooling and drying cathode exhaust gas to a downstream side of the condenser (42);
a feeder (43) downstream of the condenser (42) and configured for releasing a portion of the dried cathode exhaust gas as dry, oxygen depleted air, ODA, into the casing (13) at a pressure above a pressure of the environment (39) for maintaining elevated pressure in the interior of the casing (13) relatively to the pressure of the environment (39) around the automobile (1) for preventing ingress of air and humidity from the environment (39) into the interior of the casing (13);
a release-valve (31) arranged between the interior of the casing (13) and the environment (39) and configured for releasing the pressurised ODA from the interior of the casing (13) only to the environment (39) and not into the cabin (1A), the release-valve (31) being configured for maintaining the elevated pressure in the interior of the casing (13) and releasing the gas from the interior of the casing (13) to the environment (39) only if the pressure of the gas in the interior is above a predetermined pressure level; wherein the automobile is configured for
operating the fuel cell (6) and charging the battery (12) with electrical power from the fuel cell (6);
automatically as a standard procedure, independently of the hydrogen level in the casing (13), and during all times of operation of the fuel cell, causing flow of a portion of the cooled dry cathode exhaust gas through the feeder (43) into the interior and through the interior to the release-valve (31) and through the release-valve (31) out of the interior into the environment (39), but not into the cabin (1A), for reducing fire-risk by creating reduced oxygen levels inside the interior of the casing (13) during all times of operation of the fuel cell (6) and by flushing potentially leaked hydrogen gas out of the interior and by removing heat from the interior;
while providing a flow of ODA through the interior of the casing (13) and out of the release-valve (31), maintaining the elevated pressure in the interior of the casing (13) for preventing ingress of dust and water from the environment (39) into the interior.

ASPECT 13. Automobile according to aspect 12, wherein the automobile (1) comprises an air compressor (40) flow-connected to an inlet of the cathode (6A) and adjusted for providing pressurised air to the cathode (6A), and wherein the automobile (1) comprises a back-pressure-valve (41), different from the release-valve (31), located in a flow path between the condenser (42) and an exhaust (3) to the environment (39), wherein the back-pressure-valve (41) is adjusted for maintaining a fuel-cell-back-pressure for the fuel cell (6) at a level in the range of 0.5-2 bar above environmental pressure P0; wherein the feeder is a feeder-valve (43) provided in the flow path between the condenser (42) and the back-pressure-valve (41) and configured for releasing only a portion of the dry cathode gas through the feeder-valve (43) into the casing (13); wherein the release-valve (31) is adjusted for maintaining a pressure in the interior of the casing (13) at a level in the range of 0.02-0.2 bar above P0 during a flow of ODA through the casing (13) from the feeder-valve (43) to the release-valve (31).

ASPECT 14. Automobile according to aspect 12 or 13, wherein the casing (13) comprises a fuel cell compartment (16) that contains the fuel cell (6) and an electronics compartment (17) that contains electronics (10, 20), including a controller (10) for power management, and wherein an insulating wall (23) is provided between the two compartments (17, 20) for protecting the electronic power management system (20) against heat from the fuel cell (6), wherein the interior also comprises a reformer compartment (15) than contains a reformer (8) for catalytic reaction of alcohol and water into syngas for the fuel cell (6) and an insulating wall (22) between the reformer compartment (15) and the fuel cell compartment (16), wherein the temperature during operation is higher in the fuel cell compartment (16) than in the electronics compartment (17) and higher in the reformer compartment (15) than in the fuel cell compartment (16), and wherein the casing (13) comprises a flow path for the ODA from the feeder (43) through the electronics compartment (17), then through the fuel cell compartment (16), then through the reformer compartment (15) for removal of heat successively from the electronics compartment (17), the fuel cell compartment (16) and the reformer compartment (15), wherein the release-valve (31) is provided at the reformer compartment (15) for release of the ODA into the environment (39) from the reformer compartment (15).

ASPECT 15. Automobile according to aspect 12, 13, or 14, wherein the interior of the casing (13) also comprises a battery compartment (14) that contains the battery (12), and wherein the flow of the ODA is not through the battery compartment (14).

ASPECT 16. Automobile according to anyone of the aspects 12-15, wherein the fuel cell (6) is a high temperature polymer electrolyte membrane HT-PEM fuel cell, and the automobile is configured for operating the fuel cell (6) at a temperature in the range of 120-200° C.

ASPECT 17. A method of fire-risk mitigation in an electrically powered automobile (1), the automobile (1) comprising
a cabin (1A);
electrical engines (37) for rotating wheels (36) of the automobile (1);
a power-pack (30) for providing electrical power to the engines (37); wherein the power-pack (30) is arranged underneath the cabin (1A) and comprises a closed casing (13) with an interior that contains a battery (12) as well as a fuel cell (6) for charging the battery (12);
a condenser (42) inside the casing (13), the condenser (42) having an upstream side flow-connected to a downstream of a cathode (6A) of the fuel cell (6) for receiving cathode exhaust gas from the fuel cell (6) and for condensing water out of the cathode exhaust gas and for cooling and drying cathode exhaust gas to a downstream side of the condenser (42);
a feeder (43) downstream of the condenser (42) and configured for releasing a portion of the dried cathode exhaust gas as dry, oxygen depleted air, ODA, into the casing (13) at a pressure above a pressure P0 of the environment (39) for maintaining elevated pressure in the interior of the casing (13) relatively to the pressure P0 of the environment (39) around the automobile (1) for preventing ingress of air and humidity from the environment (39) into the interior of the casing (13);
a release-valve (31) arranged between the interior of the casing (13) and the environment (39) and configured for releasing the pressurised ODA from the interior of the casing (13) only to the environment (39) and not into the cabin (1A), the release-valve (31) being configured for maintaining the elevated pressure in the interior of the casing (13) and releasing the gas from the interior of the casing (13) to the environment (39) only if the pressure of the gas in the interior is above a predetermined pressure level P1; wherein the release-valve (31) is a one-way release-valve having a closure member (31A) resiliently prestressed against a valve seat with a resilient force against flow through the release-valve (31) and configured for opening for flow through the release-valve (31) from the interior to the environment only when the pressure difference between the pressure in the interior and the pressure of the environment P0 provides a counterforce on the closure member (31A) exceeding the resilient force; the method comprising
operating the fuel cell (6) and charging the battery (12) with electrical power from the fuel cell (6);
automatically as a standard procedure, independently of the hydrogen level in the casing (13), and during all times of operation of the fuel cell, causing flow of a portion of the cooled dry cathode exhaust gas through the feeder (43) into the interior and through the interior to the release-valve (31) and through the release-valve (31) out of the interior into the environment (39), but not into the cabin (1A), for reducing fire-risk by creating reduced oxygen levels inside the interior of the casing (13) during all times of operation of the fuel cell (6) and by flushing potentially leaked hydrogen gas out of the interior and by removing heat from the interior;
while providing a flow of ODA through the interior of the casing (13) and out of the release-valve (31), maintaining the elevated pressure in the interior of the casing (13) for preventing ingress of dust and water from the environment (39) into the interior, wherein the automobile (1) comprises an air compressor (40) flow-connected to an inlet of the cathode (6A) for providing pressurised air to the cathode (6A), and wherein the automobile (1) comprises a back-pressure-valve (41), different from the release-valve (31), located in a flow path between the condenser (42) and an exhaust (3) to the environment (39) for maintaining a fuel-cell-back-pressure for the fuel cell (6), wherein the feeder (43) is provided in the flow path between the condenser (42) and the back-pressure-valve (41); wherein the method comprises maintaining a back-pressure with the back-pressure-valve at a predetermined level P2 and releasing a portion of the dry cathode gas through the feeder (43) at a lower pressure into the casing (13), wherein the method comprises maintaining a back-pressure P2 by the back-pressure-valve in the range of 0.5-2 bar (1 bar=100 kPa) above environmental pressure, wherein the method comprises providing a flow through the feeder (43) only to a level that provides a pressure P1 in the interior of the casing in the range of 0.05-0.2 bar (1 bar=100 kPa) above environmental pressure P0, wherein the feeder (43) is a feeder-valve and wherein the method comprises operating the feeder-valve (43) so as to provide a predetermined steady flow of ODA through the casing (13) from the feeder-valve (43) to the release-valve (31) at all times when the fuel cell (6) is operating.

ASPECT 18. A method according to aspect 17, wherein the cooled dried cathode exhaust gas is provided from the condenser (42) at a temperature T2 which is below 60° C., for example in the range of 20-60° C.

ASPECT 19. A method according to aspect 18, wherein the fuel cell (6) is a high temperature polymer electrolyte membrane HT-PEM fuel cell, and the method comprises operating the fuel cell (6) at a temperature in the range of 120-200° C.

ASPECT 20. A method according to aspect 17, 18 or 19, wherein the flow of dried cathode exhaust gas as ODA through the interior of the casing (13) is without addition of air or other gases.

ASPECT 21. An electrically powered automobile (1), the automobile (1) comprising
a cabin (1A);
electrical engines (37) for rotating wheels (36) of the automobile (1);
a power-pack (30) for providing electrical power to the engines (37); wherein the power-pack (30) is arranged underneath the cabin (1A) and comprises a closed casing (13) with an interior that contains a battery (12) as well as a fuel cell (6) for charging the battery (12);
a condenser (42) inside the casing (13), the condenser (42) having an upstream side flow-connected to a downstream of a cathode (6A) of the fuel cell (6) for receiving cathode exhaust gas from the fuel cell (6) and for condensing water out of the cathode exhaust gas and for cooling and drying cathode exhaust gas to a downstream side of the condenser (42);
a feeder (43) downstream of the condenser (42) and configured for releasing a portion of the dried cathode exhaust gas as dry, oxygen depleted air, ODA, into the casing (13) at a pressure above a pressure of the environment (39) for maintaining elevated pressure in the interior of the casing (13) relatively to the pressure of the environment (39) around the automobile (1) for preventing ingress of air and humidity from the environment (39) into the interior of the casing (13);
a release-valve (31) arranged between the interior of the casing (13) and the environment (39) and configured for releasing the pressurised ODA from the interior of the casing (13) only to the environment (39) and not into the cabin (1A), the release-valve (31) being configured for maintaining the elevated pressure in the interior of the casing (13) and releasing the gas from the interior of the casing (13) to the environment (39) only if the pressure of the gas in the interior is above a predetermined pressure level P1, wherein the release-valve (31) is a one-way release-valve having a closure member (31A) resiliently prestressed against a valve seat with a resilient force against flow through the release-valve (31) and configured for opening for flow through the release-valve (31) from the interior to the environment only when the pressure difference between the pressure in the interior and the pressure of the environment P0 provides a counterforce on the closure member (31A) exceeding the resilient force; wherein the automobile is configured for
operating the fuel cell (6) and charging the battery (12) with electrical power from the fuel cell (6);
automatically as a standard procedure, independently of the hydrogen level in the casing (13), and during all times of operation of the fuel cell, causing flow of a portion of the cooled dry cathode exhaust gas through the feeder (43) into the interior and through the interior to the release-valve (31) and through the release-valve (31) out of the interior into the environment (39), but not into the cabin (1A), for reducing fire-risk by creating reduced oxygen levels inside the interior of the casing (13) during all times of operation of the fuel cell (6) and by flushing potentially leaked hydrogen gas out of the interior and by removing heat from the interior;
while providing a flow of ODA through the interior of the casing (13) and out of the release-valve (31), maintaining the elevated pressure in the interior of the casing (13) for preventing ingress of dust and water from the environment (39) into the interior,
   wherein the automobile (1) comprises an air compressor (40) flow-connected to an inlet of the cathode (6A) and adjusted for providing pressurised air to the cathode (6A), and
   wherein the automobile (1) comprises a back-pressure-valve (41), different from the release-valve (31), located in a flow path between the condenser (42) and an exhaust (3) to the environment (39), wherein the back-pressure-valve (41) is adjusted for maintaining a fuel-cell-back-pressure for the fuel cell (6) at a level in the range of 0.5-2 bar above environmental pressure P0;
   wherein the feeder is a feeder-valve (43) provided in the flow path between the condenser (42) and the back-pressure-valve (41) and configured for releasing only a portion of the dry cathode gas through the feeder-valve (43) into the casing (13);
   wherein the release-valve (31) is adjusted for maintaining a pressure in the interior of the casing (13) at a level in the range of 0.02-0.2 bar above P0 during a flow of ODA through the casing (13) from the feeder-valve (43) to the release-valve (31).

ASPECT 22. Automobile according to aspect 20, wherein the cooled dried cathode exhaust gas from the condenser (42) during operation has a temperature T2 which is below 60° C., for example in the range of 20-60° C. and wherein the fuel cell (6) is a high temperature polymer electrolyte membrane HT-PEM fuel cell, wherein the automobile is configured for operating the fuel cell (6) at a temperature in the range of 120-200°° C.

### DESCRIPTION OF THE DRAWING

Embodiments of the invention will be described in the figures, wherein:

FIG. 1 illustrates an automobile

FIG. 2 illustrates a chassis of an automobile containing a hybrid energy pack,

FIG. 3 illustrates the hybrid energy pack in greater detail;

FIG. 4 illustrates the casing with release-valves:

FIG. 5. is a principle sketch of a simplified air passage through the fuel cell system; shows a top part of a power-pack in which valves release overpressure gas;

FIG. 6 illustrates flow of gas through the casing.

### DETAILED DESCRIPTION OF THE INVENTION

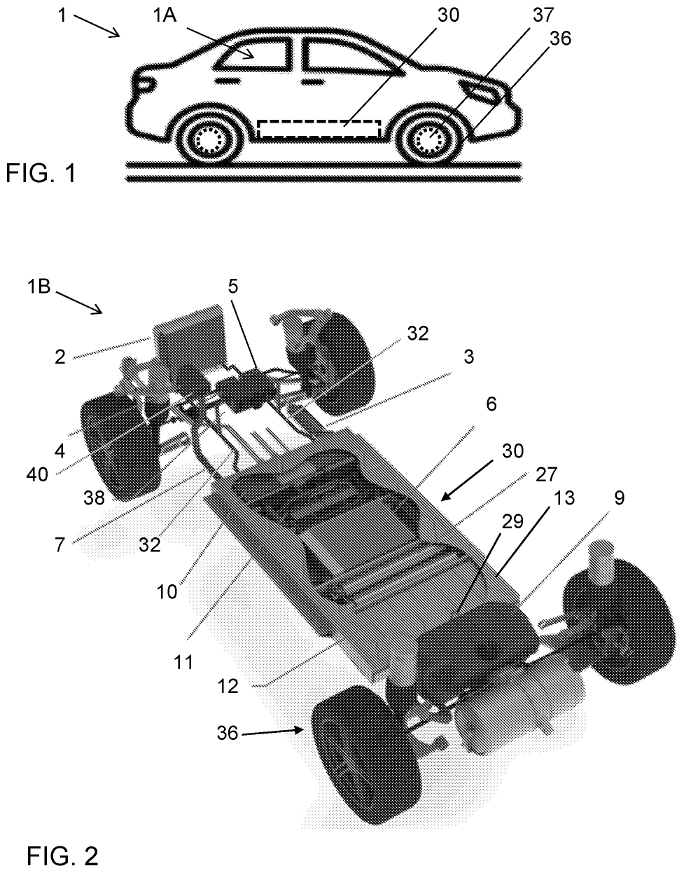

FIG. 1 illustrates an electrically driven automobile 1 with a cabin 1A and a power-pack 30 arranged under the cabin 1A. The power-pack 30 is providing electricity to electrical motors 37 that rotate the wheels 36 of the automobile 1.

FIG. 2 illustrates a chassis 1B of an automobile 1 with a fuel cell 6, in the form of a fuel cell stack, and a battery 12. Fuel is provided from a fuel tank 9. For example, the fuel tank 9 contains alcohol, optionally methanol, to which water is added prior to catalytic transformation in a burner/reformer combination 27 for providing it as hydrogen fuel to the fuel cell 6 stack. However, it is also possible that the fuel tank 9 comprises hydrogen gas.

The fuel cell 6 stack delivers electricity to the batteries 12 for charging the batteries 12. An exhaust 3 releases gases from the fuel cell 6 system.

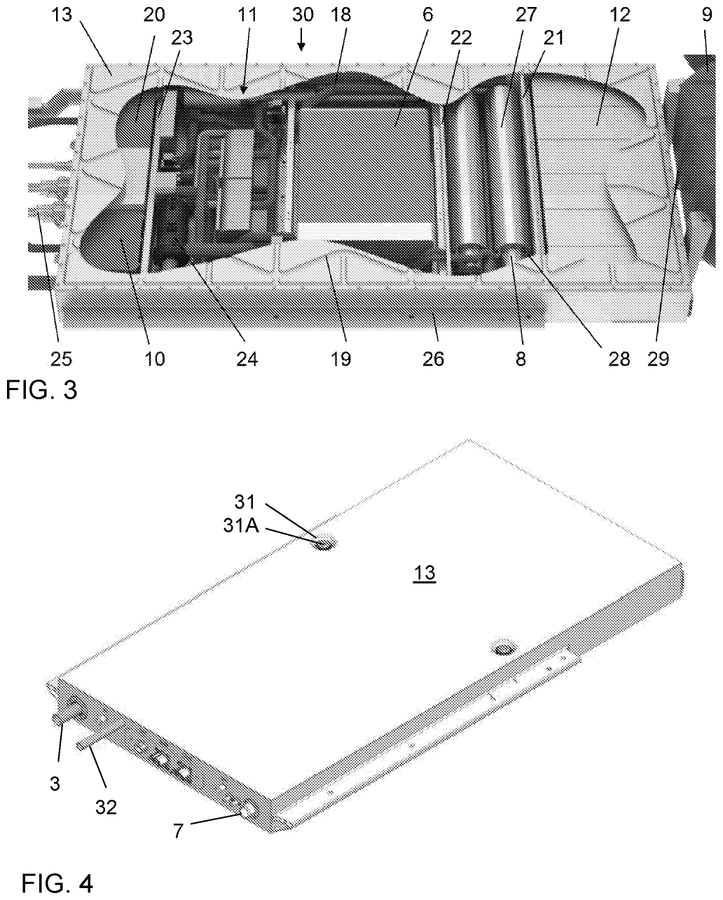

FIG. 3 illustrates further details of the power-pack 30. The fuel cell 6 stack and the batteries 12 are contained in a casing 13 which is box-shaped and with walls 19 forming bottom and top and sides to form the casing 13, preferably insulating casing. As best seen in FIG. 2, the casing 13 is held inside a frame 26. The casing 13 forms a tight enclosure in the sense that no dust and water from the environment can enter the interior of the casing 13.

The fuel cell system comprises a fuel cell 6 stack, a combination 27 of the reformer 8 and corresponding reformer burner 28, and a temperature regulation system 11, including a liquid cooling circuit 18. In addition, the electronic controller 10 is provided, which also controls the power management of the fuel cells 6. Typically, further necessary electronics 20 are necessary for the operation and/or electronic communication with the rest of the vehicle.

The reformer 8 has to be heated by the reformer burner 28 in order to convert the liquid fuel, for example methanol and water, into syngas for providing hydrogen gas the fuel cell 6. Additionally, the fuel cell 6 operates at elevated temperatures. This produces substantial amounts of heat which have to be removed.

As an example, in the reformer 8, the mix of methanol CH₃OH and water H₂O is catalytically converted into hydrogen gas H₂ and CO₂. Simplified, the methanol CH₃OH is converted into 2H₂ and CO, and the water molecule splits into H₂ and O, where the oxygen is captured by the CO to produce CO₂. The mix of H₂ and CO₂ is then supplied as so-called syngas to the anode side of the fuel cell, typically fuel cell 6 stack. Air from the environment is drawn in through an air filter 4, compressed in a compressor 40, flowing through air supply pipe 7 and supplied to the cathode of the fuel cell 6 in order to provide the necessary oxygen for the reaction with the hydrogen to produce water, after hydrogen ions H+ have passed a membrane from the anode side to the cathode side.

For example, the fuel cell 6 is a high temperature polymer electrolyte membrane (HT-PEM) fuel cell. Typically, high temperature fuel cells operate in the temperature range of 120-200° C., and thus are producing heat as well. For example, the fuel cell 6 operates at a temperature of 175° C. This operation temperature is held constant by a correspondingly adjusted flow of coolant in a cooling circuit 18 through the fuel cell 6. For example the temperature of the coolant at the coolant inlet of the fuel cell 6 is in the range of 160°° C. to 170° C.

As an option, in order to control the temperature of the individual components, the components are separated into compartments of the box shaped casing 13. In a first compartment, the battery compartment 14, the batteries 12 are provided. A separate compartment, namely a reformer compartment 15, is provided for the combined reformer 8 and burner 28. A third compartment, which is a fuel cell compartment 16, is used for the fuel cell 6 stack. Optionally, it also contains the temperature regulation system 11 and the main components of the cooling circuit 18, although, these are typically provided in a separate compartment. A fourth compartment, which is an electronics compartment 17 houses the power management system 10.

Between the battery compartments 14 and the fuel cell system, a first insulating wall 21 is provided. This first insulating wall 21 insulates and thermally separates the battery 12 from the heat that is produced by the fuel cell system, including the fuel cell 6 stack and the reformer 8 and its burner 28. By thermally separating the compartments 15, 16 of the fuel cell system 6, 8, 10, 11, 20 from the battery compartment 14 by a first insulating wall 21, the temperature of the battery 12 and the fuel cell system 6, 8, 10, 11, 20 can be adjusted better and more precise than without the first insulating wall 21.

By regulating the flow from the liquid cooling circuit 18 with respect to each of the heat-producing components, including the fuel cells 6, the reformer 8, and the temperature regulation system 11, a thorough temperature control is obtained for the system. Flow meters and valves as well as temperature gauges electronically, electrically and functionally connected to a controller 10 allows a proper computerized management of the temperature of each of the components.

Optionally, in order to control the temperature of the fuel cell stack more precisely, a second insulating wall 22 is provided between the fuel cell 6 stack and the reformer 8 with its burner 28. This is another advantageous feature, as it allows a precise adjustment and maintenance of the correct temperature of the fuel cell.

Electronics are influenced by high temperature and should be thermally protected. For this reason, a third insulating wall 23 is provided between the electronics compartment 17 and the fuel cell compartment 16.

In order to remove heat from the fuel cell 6 system, the liquid coolant is flowing through a radiator 2, for example in the front of the automobile 1, as illustrated in FIG. 1, and then supplied to the power pack 30 through corresponding coolant pipes 32, which is a common way of releasing thermal energy from the system. Some of the heat can be used for heating the cabin 1A, which is regulated in an air conditioning and heating system 38.

However, the precise temperature of the fuel cell system 6, 8, 11 and the battery 12 is controlled in a controller 10, which provides temperature management by controlling the flow of the coolant through the various components.

Advantageously, the fuel cell system comprises a startup heater 24 for providing thermal energy to raise the temperature of the fuel cell system to the correct temperature for power-producing operation.

For connection to the radiator 2 and for receiving fuel from the fuel tank 9, as well as delivering electrical power, the power-pack has corresponding connectors 25.

FIG. 4 illustrates a power-pack 30 comprising two pre-stressed non-return release-valves 31 for release of gas from the inner volume of the casing 13. When ODA is provided inside the casing 13 of the power-pack 30, it is kept at a pressure above the pressure of the environment, and the ODA is released through the release-valves 31 due to the continuous addition of new ODA into the interior of the casing 13.

As an example, release-valve 31 is a one-way release-valve having a closure member 31A resiliently prestressed against a valve seat with a resilient force against flow through the release-valve 31 and configured for opening for flow through the release-valve 31 from the interior of the casing 13 to the environment only when the pressure difference between the pressure in the interior and the pressure of the environment provides a counterforce on the closure member exceeding the resilient force.

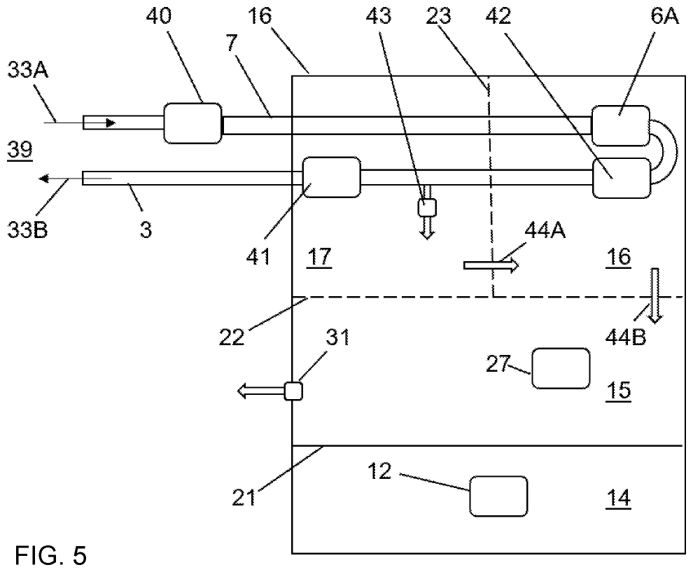

FIG. 5 is a simplified sketch for a part of an airflow through the fuel cell 6 system. From the environment 39 around the automobile, an air inflow 33A through a compressor 40 delivers compressed air through the air supply pipe 7 into the casing and supplies air to the cathode 6A of the fuel cell 6. The exhaust air from the cathode 6A is then traversing a condenser 42, in which water is removed from the exhaust air, leaving a flow of dried and cooled oxygen depleted air, ODA, downstream of the condenser 42. For example, the exhaust air from the cathode 6A is at a temperature in the range of 120-200° C., such as in the range of 150-170° C., and the temperature of the ODA downstream of the condenser is in the range of 20-60° C., for example in the range of 40-60° C.

In order to maintain the pressure in the fuel cell, a back-pressure-valve 41 is provided downstream of the condenser 42. For example, the pressure of the ODA is kept by the back-pressure-valve 41 at a predetermined pressure within the interval of 0.5-2 bar, such as 1-2 bar, above the pressure of the environment. From the back-pressure-valve 41, the ODA is released through the exhaust 3 into the environment 39.

Typically, only a minor portion of the dried and cooled ODA is released into the electronics compartment 17 of the casing 13 through a feeder-valve 43. The pressure in the casing 13 is kept slightly above environmental pressure, for example in the range of 0.02-0.1 bar, optionally 0.05-0.1 bar, above environmental pressure. Due to the fact that the pressure of the ODA upstream of the feeder-valve 43 is higher, for example an order of magnitude higher, there is no need for a further pump that transports the ODA into the interior of the casing 13. This minimizes the necessity of components and saves weight. The ODA traverses the electronics compartment 17 and thereby cools the electronics, before it flows into the fuel cell compartment 16, which is typically at higher temperature than the electronics compartment so that the ODA can take up further heat. Traversing the compartments, the ODA removes not only heat and but also potential hydrogen gas that may have leaked into the compartments 16 from the fuel cell 6.

In those embodiments where the casing 13 also comprises a combination 27 of a burner and reformer, also heat and potential hydrogen gas is removed from the corresponding reformer compartment 15 by the ODA. Typically, the temperature in the burner/reformer compartment 15 is higher than in the fuel cell compartment 16 so that the ODA is increasingly heated when flowing from one compartment to the next. The ODA from the burner/reformer compartment 15 is released through the release-valve 31 into the environment. As the temperature in the burner/reformer compartment 15 is higher than in the battery compartment 14, there is no flow from the burner/reformer compartment 15 into the battery compartment 14. If the battery compartment 14 has to be cooled as well, the ODA would traverse the battery compartment 14 before traversing the fuel cell compartment 16, as the fuel cell compartment 16 typically has a higher temperature, in particular when using high temperature fuel cells, such as HT-PEM fuel cells.

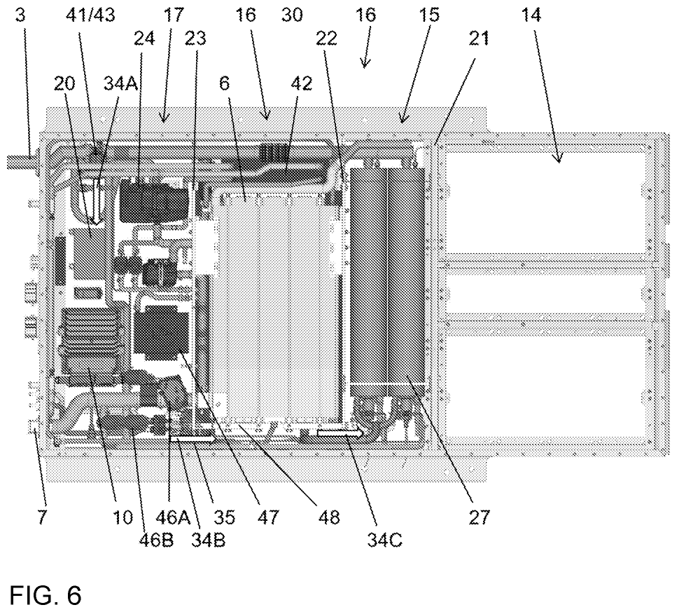

FIG. 6 shows a slightly different arrangement of the power-pack 30 with a battery compartment 14, a reformer compartment 15, a fuel cell compartment 16, and an electronics compartment 17. In this example, the startup heater 24 is located in the electronics compartment 17. In this electronics compartment 17, there is also provided the controller 10 for the fuel cell system as well as the further electronics 20. Additionally, the electronics compartment 17 houses a water buffer 47.

Compressed air enters the casing 13 through supply pipe 7 and is distributed to the fuel cell 6 stack and the burner/reformer combination 27 by corresponding valves 46A, 46B. From the fuel cell 6 and the burner/reformer combination 27, exhaust air enters the condenser 42, which removes water from the cathode exhaust gas. The water is advantageously stored in water buffer 47 for recycling. From the dried and cooled ODA downstream of the condenser 42, a portion is fed through feeder-valve 43 as a stream of ODA into the electronics compartment 17, which is illustrated by arrow 34A. In the shown embodiments, the feeder-valve 43 is combined with the back-pressure-valve 41. From the electronics compartment 17, the ODA flows into the fuel cell compartment 16, as illustrated with arrow 34B and further into the reformer compartment 15, as illustrated by arrow 34C. From there, it is released to the environment through release-valves 31, which were shown in FIG. 4.

In order to ensure a proper flow through the compartments with a broad coverage of the space that is flushed by the ODA, flow guides and further flow channels can be arranged as needed.

Due to the counterpressure from the release-valves 31, the elevated pressure prevents ingress of outside air that contains humidity, so that a dry environment is kept inside the casing 13.

Thus, one the one hand, the thermally insulating walls 21-23 prevent heat exchange between the compartments 14-17, and, on the other hand, the flow of the ODA through the casing 13 has a cooling effect, while at the same time reducing the oxygen content and flushing out potential H2 that is leaking from the fuel cells. The flushing by the cool, dust-free ODA also potentially removes smaller particles that may occur inside the casing 13.

Optionally, as a further precautionary measure, an H2 sensor is integrated in the casing 13, which gives an alarm and potentially shuts down the fuel cell, if the H2 concentration becomes too high. It is pointed out that a shut down of the fuel cell would not immediately lead to a halt of the automobile, as the batteries would be available for driving the electrical engines.

Due to the ODA being provided by the fuel cell during operation and available from the condenser as soon as the fuel cell 6 is operating, the flushing, cooling, and humidity-protecting elevated pressure inside the casing 13 is available as soon as the fuel cells 6 are started and is available at all times as long as the fuel cells 6 are operating. This is an important advantage comparison with the prior art, as the fire protection system, this way, is available and operating at all relevant times and does not need a specific controller that takes decisions only on the basis of measurements of concentrations of hydrogen and oxygen levels in specific compartments. This simplification is important due to weight considerations and simplicity of the system.

### REFERENCE NUMBERS

1 automobile

1A cabin of automobile 1

1B chassis of automobile 1

2 radiator

3 exhaust

4 air filter

5 aircon and heat controller

6 fuel cell stack

6A cathode of fuel cell

7 Air supply pipe

8 reformer

9 fuel tank

10 controller for fuel cell system, including power management

11 temperature regulation system

12 battery

13 casing which is box-shaped

14 battery compartment for the batteries 12,

15 reformer compartment for the combination 27 of reformer 8 and burner 28,

16 fuel cell compartment for the fuel cell 6 stack

17 electronics compartment for the controller 10

18 cooling circuit

19 walls of casing 13

20 further electronics

21 first insulating wall

22 second insulating wall

23 third insulating wall

24 startup heater

25 connectors

26 frame

27 combination of reformer 8 and reformer-burner 28

28 reformer-burner

29 fuel pipe

30 power-pack

31 release-valves

31A closure member of release-valve 31

32 coolant supply tube

33A airflow in

33B airflow out

34A, 34B, 34C ODA flow arrows

36 wheels

37 electrical engines

38 air condition and heating system

39 environment

40 compressor

41 back-pressure-valve

42 condenser

43 feeder-valve

44 ODA flow direction

46A, 46B valves for air supply to fuel cell and reformer burner

47 water buffer

48 evaporator

1. A method of fire-risk mitigation in an electrically powered automobile, the automobile comprising
a cabin;
electrical engines for rotating wheels of the automobile;
a power-pack for providing electrical power to the engines; wherein the power-pack is arranged underneath the cabin and comprises a closed casing with an interior that contains a battery as well as a fuel cell for charging the battery;
a condenser inside the casing, the condenser having an upstream side flow-connected to a downstream of a cathode of the fuel cell for receiving cathode exhaust gas from the fuel cell and for condensing water out of the cathode exhaust gas and for cooling and drying cathode exhaust gas to a downstream side of the condenser;
a feeder downstream of the condenser and configured for releasing a portion of the dried cathode exhaust gas as dry, oxygen depleted air, ODA, into the casing at a pressure above a pressure P0 of the environment for maintaining elevated pressure in the interior of the casing relatively to the pressure P0 of the environment around the automobile for preventing ingress of air and humidity from the environment into the interior of the casing;
a release-valve arranged between the interior of the casing and the environment and configured for releasing the pressurised ODA from the interior of the casing only to the environment and not into the cabin, the release-valve being configured for maintaining the elevated pressure in the interior of the casing and releasing the gas from the interior of the casing to the environment only if the pressure of the gas in the interior is above a predetermined pressure level P1;
the method comprising
operating the fuel cell and charging the battery with electrical power from the fuel cell;
automatically as a standard procedure, independently of the hydrogen level in the casing, and during all times of operation of the fuel cell, causing flow of a portion of the cooled dry cathode exhaust gas through the feeder into the interior and through the interior to the release-valve and through the release-valve out of the interior into the environment, but not into the cabin, for reducing fire-risk by creating reduced oxygen levels inside the interior of the casing during all times of operation of the fuel cell and by flushing potentially leaked hydrogen gas out of the interior and by removing heat from the interior;
while providing a flow of ODA through the interior of the casing and out of the release-valve, maintaining the elevated pressure in the interior of the casing for preventing ingress of dust and water from the environment into the interior.

2. A method according to claim 1, wherein the casing comprises a fuel cell compartment that contains the fuel cell and an electronics compartment that contains electronics, including a controller for the fuel cell system, and wherein an insulating wall is provided between the two compartments for protecting the electronics against heat from the fuel cell, wherein the method comprises providing a flow of the ODA first through the electronics compartment and then through the fuel cell compartment and removing heat first from the electronics compartment and then from the fuel cell compartment.

3. A method according to claim 2, wherein the interior of the casing also comprises a reformer compartment than contains a reformer for catalytic reaction of alcohol and water into syngas for the fuel cell and an insulating wall between the reformer compartment and the fuel cell compartment, and wherein the method comprises providing flow through the fuel cell compartment prior to flow through the reformer compartment, wherein the release-valve is provided at the reformer compartment for release of the ODA into the environment from the reformer compartment, wherein the method comprises providing the flow through the electronics compartment, then through the fuel cell compartment, then through the reformer compartment, then through the valve and into the environment.

4. A method according to claim 2, wherein the interior also comprises a battery compartment that contains the battery, and wherein the method comprises providing the flow of ODA is not through the battery compartment.

5. A method according to claim 1, wherein the automobile comprises an air com-pressor flow-connected to an inlet of the cathode for providing pressurised air to the cathode, wherein the automobile comprises a back-pressure-valve different from the release-valve and located in a flow path between the con-denser and an exhaust to the environment for maintaining a fuel-cell-back-pressure for the fuel cell, wherein the feeder is a feeder valve and pro-vided in the flow path between the condenser and the back-pressure-valve; wherein the method comprises
maintaining a back-pressure with the back-pressure-valve at a predetermined level P2 and releasing a portion of the dry cathode gas through the feeder at a lower pressure into the casing,
maintaining a back-pressure P2 by the back-pressure-valve in the range of 0.5-2 bar (1 bar=100 kPa) above environmental pressure,
providing a flow through the feeder only to a level that provides a pressure in the interior of the casing in the range of 0.05-0.2 bar (1 bar=100 kPa) above environmental pressure P0,
operating the feeder-valve so as to provide a predetermined steady flow of ODA through the casing from the feeder-valve to the release-valve at all times when the fuel cell is operating.

6. The method according to claim 5, wherein the release-valve is a one-way release-valve having a closure member resiliently prestressed against a valve seat with a resilient force against flow through the release-valve and configured for opening for flow through the release-valve from the interior to the environment only when the pressure difference between the pressure in the interior and the pressure of the environment P0 provides a counterforce on the closure member exceeding the resilient force.

7. A method according to claim 1, wherein the method comprises providing the flow of dried cathode exhaust gas as ODA through the interior of the casing is without addition of air or other gases.

8. A method according to claim 1, wherein method comprises providing the cooled dried cathode exhaust gas from the condenser at a temperature T2 which is below 60° C., for example in the range of 20-60° C.

9. A method according to claim 1, wherein the fuel cell is a high temperature polymer electrolyte membrane HT-PEM fuel cell, and the method comprises operating the fuel cell at a temperature in the range of 120-200° C.

10. An electrically powered automobile, the automobile comprising
a cabin;
electrical engines for rotating wheels of the automobile;
a power-pack for providing electrical power to the engines; wherein the power-pack is arranged underneath the cabin and comprises a closed casing with an interior that contains a battery as well as a fuel cell for charging the battery;
a condenser inside the casing, the condenser having an upstream side flow-connected to a downstream of a cathode of the fuel cell for receiving cathode exhaust gas from the fuel cell and for condensing water out of the cathode exhaust gas and for cooling and drying cathode exhaust gas to a downstream side of the condenser;
a feeder downstream of the condenser and configured for releasing a portion of the dried cathode exhaust gas as dry, oxygen depleted air, ODA, into the casing at a pressure above a pressure of the environment for maintaining elevated pressure in the interior of the casing relatively to the pressure of the environment around the automobile for preventing ingress of air and humidity from the environment into the interior of the casing;
a release-valve arranged between the interior of the casing and the environment and configured for releasing the pressurised ODA from the interior of the casing only to the environment and not into the cabin, the release-valve being configured for maintaining the elevated pressure in the interior of the casing and releasing the gas from the interior of the casing to the environment only if the pressure of the gas in the interior is above a predetermined pressure level;
wherein the automobile is configured for
operating the fuel cell and charging the battery with electrical power from the fuel cell;
automatically as a standard procedure, independently of the hydrogen level in the casing, and during all times of operation of the fuel cell, causing flow of a portion of the cooled dry cathode exhaust gas through the feeder into the interior and through the interior to the release-valve and through the release-valve out of the interior into the environment, but not into the cabin, for reducing fire-risk by creating reduced oxygen levels inside the interior of the casing during all times of operation of the fuel cell and by flushing potentially leaked hydrogen gas out of the interior and by removing heat from the interior;
while providing a flow of ODA through the interior of the casing and out of the release-valve, maintaining the elevated pressure in the interior of the casing for preventing ingress of dust and water from the environment into the interior.

11. The automobile according to claim 10, wherein the casing comprises a fuel cell compartment that contains the fuel cell and an electronics compartment that contains electronics, including a controller for the fuel cell system, and wherein an insulating wall is provided between the two compartments for protecting the electronics against heat from the fuel cell, wherein the casing comprises a flow path for the ODA from the feeder through the electronics compartment and then through the fuel cell compartment for removal of heat first from the electronics compartment and then from the fuel cell compartment.

12. The automobile according to claim 11, wherein the interior also comprises a reformer compartment than contains a reformer for catalytic reaction of alcohol and water into syngas for the fuel cell and an insulating wall between the reformer compartment and the fuel cell compartment, wherein the temperature during operation is higher in the fuel cell compartment than in the electronics compartment and higher in the reformer compartment than in the fuel cell compartment, and wherein the casing comprises a flow path for the ODA from the feeder through the electronics compartment, then through the fuel cell compartment, then through the reformer compartment for removal of heat successively from the electronics compartment, the fuel cell compartment and the reformer compartment, wherein the release-valve is provided at the reformer compartment for release of the ODA into the environment from the reformer compartment, and wherein the interior of the casing also comprises a battery compartment that contains the battery, and wherein the flow of the ODA is not through the battery compartment.

13. The automobile according to claim 10,
wherein the automobile comprises an air compressor flow-connected to an inlet of the cathode and adjusted for providing pressurised air to the cathode, and
wherein the automobile comprises a back-pressure-valve, different from the release-valve, located in a flow path between the condenser and an exhaust to the environment, wherein the back-pressure-valve is adjusted for maintaining a fuel-cell-back-pressure for the fuel cell at a level in the range of 0.5-2 bar above environmental pressure P0;
wherein the feeder is a feeder-valve provided in the flow path between the condenser and the back-pressure-valve and configured for releasing only a portion of the dry cathode gas through the feeder-valve into the casing;
wherein the release-valve is adjusted for maintaining a pressure in the interior of the casing at a level in the range of 0.02-0.2 bar above P0 during a flow of ODA through the casing from the feeder-valve to the release-valve.

14. The automobile according to claim 13, wherein the release-valve is a one-way release-valve having a closure member resiliently prestressed against a valve seat with a resilient force against flow through the release-valve and configured for opening for flow through the release-valve from the interior to the environment only when the pressure difference between the pressure in the interior and the pressure of the environment P0 provides a counterforce on the closure member exceeding the resilient force.

15. The automobile according to claim 13, wherein the cooled dried cathode exhaust gas from the condenser during operation has a temperature T2 which is below 60° C., for example in the range of 20-60° C., and wherein the fuel cell is a high temperature polymer electrolyte membrane HT-PEM fuel cell, and wherein the automobile is configured for operating the fuel cell at a temperature in the range of 120-200°° C.
